(19) United States
(12) Patent Application Publication
(10) Pub. No.: US 2008/0031516 A1
(43) Pub. Date: Feb. 7, 2008

(54) Method, apparatus and system providing hue calculation

(75) Inventor: Igor Subbotin, South Pasadena, CA (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/498,826

(22) Filed: Aug. 4, 2006

(51) Int. Cl. G06K 9/00; H04N 5/225; H04N 9/04

(52) U.S. Cl. 382/162; 348/207.99

(57) ABSTRACT

A method of determining pixel hue values from red, green, and blue color component inputs. The hue color circle is divided into a number of segments. Each segment is assigned an output hue value. A set of conditionals are provided to describe each segment, define the outputs and create a data set that may be loaded into a system to provide hue determination without complex division or multiplication operations.

### FIELD OF INVENTION

The invention relates generally to image processing and more specifically to hue calculation in image processing.

### BACKGROUND OF THE INVENTION

In various electronic systems involved in image detection and digital image processing including but not limited to cameras, scanners and other image processing systems, there is often a need to calculate the hue of a color detected by the device.

Hue is an aspect of color measurement representing the type of color being defined. In the HSL (hue, saturation, luminance) color space, hue is represented as an angle in the color circle. Color circle values range from 0° to 360°, where 0° is equal to 360°, red is positioned at 0°, green is positioned at 120°, and blue is positioned at 240°. In accordance with these values, the equation for calculating hue from the RGB values where R, G, and B are between 0.0 and 1.0 may be written as:

$$H = \{ \begin{matrix}60 \times \frac{G - B}{MAX - MIN} + 0 , & if MAX = R \\ 60 \times \frac{B - R}{MAX - MIN} + 120 , & if MAX = G \\ 60 \times \frac{R - G}{MAX - MIN} + 240 , & if MAX = B\end{matrix} . \qquad Equation 1$$

where MAX equals the maximum of the RGB values, MIN equals the minimum of the RGB values and H is normalized to lie between 0° and 360°.

Using Equation 1, hue values can be calculated to a precision of one degree. However, Equation 1 contains complicated mathematical operations, requiring division and multiplication. Inclusion of such operators could prevent or severely limit the implementation of a simple circuit capable of calculating hue, particularly a circuit suitable for use in an imager system-on-a-chip (SOC), due to circuit size or speed constraints. Accordingly, a simpler method and apparatus for calculating hue is needed.

### BRIEF DESCRIPTION OF THE DRAWINGS

FIG. 1 is a block diagram of a conventional imager;

FIG. 2 is a diagram showing red, green, and blue relations in a hue color wheel having three segments;

FIG. 3 is a table showing output hue value definitions for a three segment color circle according to the present invention;

FIG. 4 is a table showing an example method of calculating a hue value according to the present invention;

FIG. 5 is a diagram showing red, green, and blue relations in a hue color wheel having twelve segments; and

FIG. 6 is a processor system incorporating at least one imager constructed in accordance with an embodiment of the invention.

### DETAILED DESCRIPTION OF THE INVENTION

In the following detailed description, reference is made to various specific embodiments in which the invention may be practiced. These embodiments are described with sufficient detail to enable those skilled in the art to practice the invention, and it is to be understood that other embodiments may be employed, and that structural and logical changes may be made without departing from the spirit or scope of the present invention.

Rather than using the conventional method and equation for calculating hue from red, green and blue color component values (RGB), various embodiments of the invention utilize a range of hue values (0°-360°) which may be approximated and represented by a limited number of output values depending on the required degree of precision. Thus, a hue value may be determined from input RGB values without using complex arithmetic operators such as multipliers and dividers.

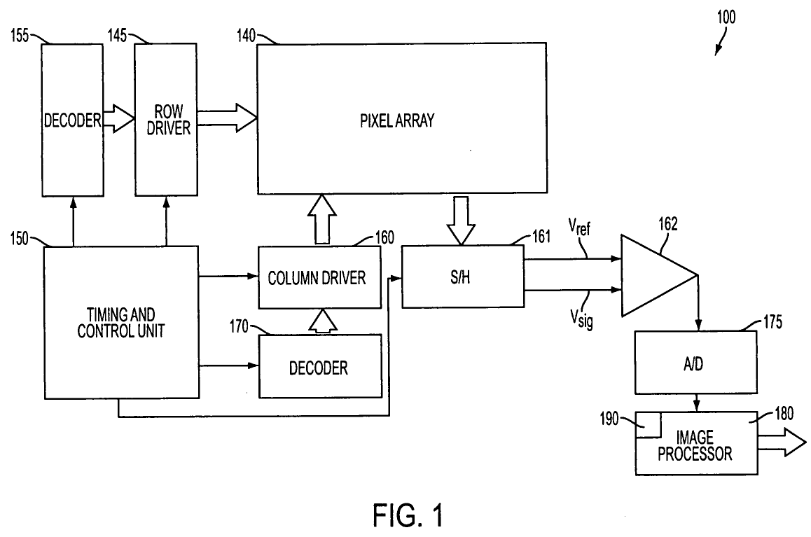

FIG. 1 illustrates a block diagram of an electronic digital image processing system, e.g., a semiconductor CMOS imager 100, having a pixel array 140 comprised of a plurality of pixel cells arranged in columns and rows which may be used to implement one embodiment of the invention. Each pixel cell is configured to receive incident photons and to convert the incident photons into electrical signals.

The pixel cells may be configured to detect only a certain color of light and may thereby be characterized according to the color. Various means may be employed to ensure collection of only the correct color of light for any such designated pixel cell. For example, pixel cells may contain photosensors that are only sensitive to a certain band of wavelengths. In this approach, certain photosensors may be sensitive only to red light, others only to green light, and still others only to blue light. Alternatively, the array may be covered by a color filter array such that each pixel receives light associated with only a particular color (e.g., red, green or blue).

The arrangement of pixel cells by color in pixel array 140 may vary. The Bayer filter is a color filter array (CFA) that is a commonly used in digital imager circuits. The Bayer filter consists of red, green and blue light filters arranged in a checkerboard-like pattern, alternating red and green in one row, blue and green in the next, red and green again in the next, and so on. The rows are aligned such that the columns alternate colors in a similar fashion.

Each color pixel cell outputs a voltage representing a band of wavelengths corresponding to the color. A red pixel cell, therefore, outputs a voltage representing the amount of photons corresponding to red light that is received by that pixel cell. Ideally, the red pixel cell would also output signals representing the amounts of photons corresponding to green and blue light that are incident to the pixel cell. To accomplish this would require relatively complicated or resource intensive circuitry. To avoid such complicated circuitry, estimate values of the missing colors output hue values may be interpolated from the outputs of neighboring pixel cells through a process referred to as a demosaic operation. In the case of an image sensor employing a Bayer pattern, such a demosaic operation yields representative red, green and blue (RGB) output hue values for each pixel cell, producing a more complete and accurate image. Other methods of determining RGB output hue values may also be used.

Pixel cells of pixel array 140 are output row-by-row as activated by a row driver 145 in response to a row address decoder 155. Column driver 160 and column address decoder 170 are used to selectively activate individual pixel columns. A timing and control circuit 150 controls address decoders 155, 170 for selecting the appropriate row and column lines for pixel readout. The control circuit 150 also controls the row and column driver circuitry 145, 160 such that driving voltages may be applied. Generally, each pixel cell outputs both a pixel reset signal Vref and a pixel image signal Vsig, which are read by a sample and hold circuit 161. Vref represents a reset state of a pixel cell. Vsig represents the amount of charge generated by the photosensor in a pixel cell in response to applied light during an integration period. The difference between Vsig and Vref represents the actual pixel cell output with common-mode noise eliminated. The differential signal (Vref-Vsig) is produced by differential amplifier 162 for each readout pixel cell. The differential signals are then digitized by an analog-to-digital converter 175. The analog-to-digital converter 175 supplies the digitized pixel signals to an image processor 180, which forms and outputs a digital image.

It should be evident that although the invention as described herein is, for convenience, described with reference to a CMOS pixel array and readout circuitry, the invention is not so limited. It can be used with any type of image array having color pixel. The image processor 180 applies various effects, algorithms, and operations to the image which require a calculation of the hue value from the red, green and blue color component values. For example, a method described in U.S. patent application Ser. 11/204,117 titled “IMAGE SAMPLING METHOD FOR AUTOMATIC WHITE BALANCE,” which is assigned to Micron, uses hue value variance to select pixels for automatic white balance statistics.

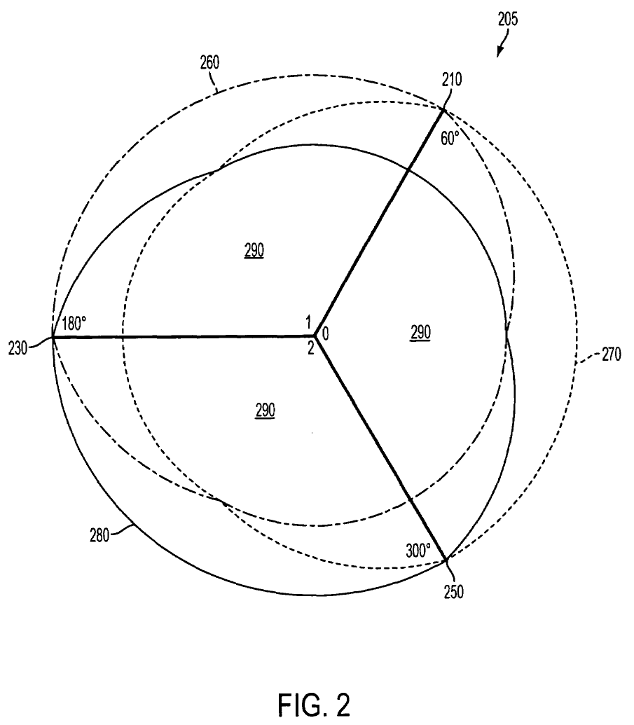

FIG. 2 is a diagram showing the ratio and progression of red component 270, green component 260 and blue component 280 color values at hue degrees around the hue color circle 205, oscillating between their respective minimum (inner circle) and maximum (outer circle) values. The red 270 and blue 280 components reach a maximum at 300° 250, where green 260 is at a minimum. The blue 230 and green 260 components reach a maximum at 180° 230, where red 270 has dropped to a minimum, and so on. According to the invention, the hue color circle 205 (0°-360°) is divided into a number of segments 290, where each segment 290 spans a set of hue degree values from a first degree value to a second degree value, e.g., 60°-180°, 180°-360°, and so on. Preferably, the segments 290 should be equal in range and the sum total of all segments 290 should cover the full range of degrees in the hue color circle 205. According to an embodiment of the invention, the total number of segments 290 preferably satisfies the equation:

S=(3)(2^{P}) Equation 2.

where P is either zero or a whole number greater than zero and S is the total number of segments 290. For a number of segments 290 satisfying Equation 2, hue values can be determined based on a set of conditionals that will not require complex arithmetic multiplication or division operators, as will be further explained below.

The hue color circle 205 may be divided into different numbers of segments 290 depending on the precision of the hue approximation that is required for a given application. FIG. 2 shows the hue color circle 205 divided into three equal segments 290 (Equation 2: P=0). The precision of the approximation is equal to 360°/S. Thus, the three segment division illustrated in FIG. 2 allows a hue calculation to a precision of 120°. For greater precision, a larger number of segments are used, e.g., 12 segments with P=2 in Equation 2.

After the hue color circle 205 has been divided, each segment 290 is assigned a unique output hue value so that each output hue value represents the range of hue values that fall within the segment. Preferably, the output hue value assignments should progress in numerical order from 0 to (number of segments—1), with output hue value 0 corresponding to a segment that includes hue circle degree value 0°, or has a border value of 0°. FIG. 2 shows the preferred output hue values assignment for three segments 290 as 0 to 2, where the 0 segment 290 includes 0°.

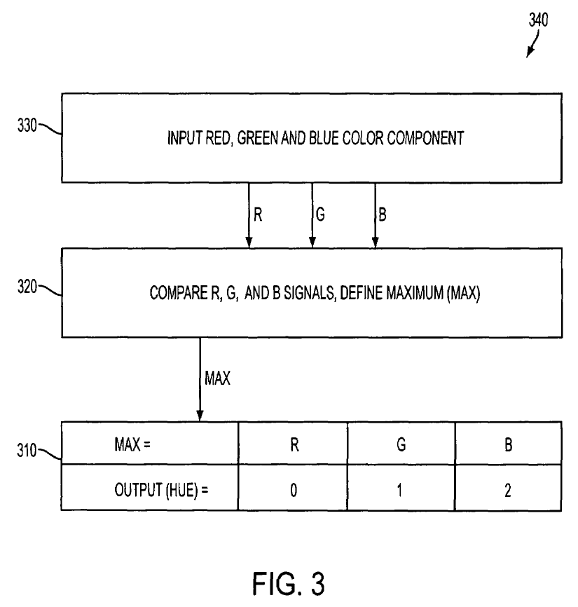

After assigning output hue values to segments 290, a table 310 is created to define output hue value conditionals and designate the segment border degree values, as shown in FIG. 3. Each output hue value must be defined by a comparative conditional or set of conditionals based on unique, identifiable traits that describe the relationships among the RGB values corresponding to any particular hue degree value. The conditionals must be true for all hue degree values within the output hue value's corresponding segment 290, also taking into account the segment's border degrees. Segment borders, for example 210, 230 and 250, are color component ratio turning points that could be designated in either adjoining segment 290, depending on the definition of the conditional.

Mathematically, the conditionals could be created in any desired number of ways since any number of variables, if-then checks or equivalent techniques could be used to describe or evaluate the traits of the color component values 260, 270, 280 within the segments 290. Preferably, the set of conditionals used to create the table should be simple rather than complex, in other words, have fewer variables and conditional checks. It should be understood, however, that the invention does not present a mathematical algorithm for determining the absolute simplest conditional or set of conditionals of all possibilities. It should also be understood that existing circuit layout or system capabilities may dictate a more complex set of conditionals and such circumstances are within the scope of this invention.

FIG. 3 is a flowchart 340 and table 310 illustrating a method of calculating hue where for Equation 2, P=0, as shown in FIG. 2, meaning that the hue color wheel is divided into three segments. To characterize each segment 290, the conditionals are based on traits describing segment 290. In this embodiment the trait can be either the minimum (MIN) or maximum (MAX) color of all three color components respectively in each segment. If the maximum value is used, the output hue value conditionals could be:

if MAX=R then output=0;
if MAX=G then output=1; and
if MAX=B then output=2.

In defining the trait or traits upon which the conditionals are based to determine the output hue value, the segment 290 border hue values must be designated as belonging to one or the other segment 290. The segment 290 border hue values for this three segment example would correspond to borders 210, 230 and 250 in FIG. 2. To create the table 310 in FIG. 3 taking these into account, at step 320 the MAX trait is defined using greater-than and greater-or-equal as follows:

if R≧B AND R>G then MAX=R;
if G≧R AND G>B then MAX=G; and
if B≧G AND B>R then MAX=B.

According to the embodiment of FIG. 3, inputting RGB values 330 from a pixel signal of 1, 0.7, 0.8, respectively, would yield an output hue value of 0. This corresponds to a hue value of between 60° and 300°, as shown in FIG. 2. Input RGB values of 1, 1, 0.8, respectively, would yield an output hue value of 1, corresponding to a hue value between 180° and 60° (FIG. 2).

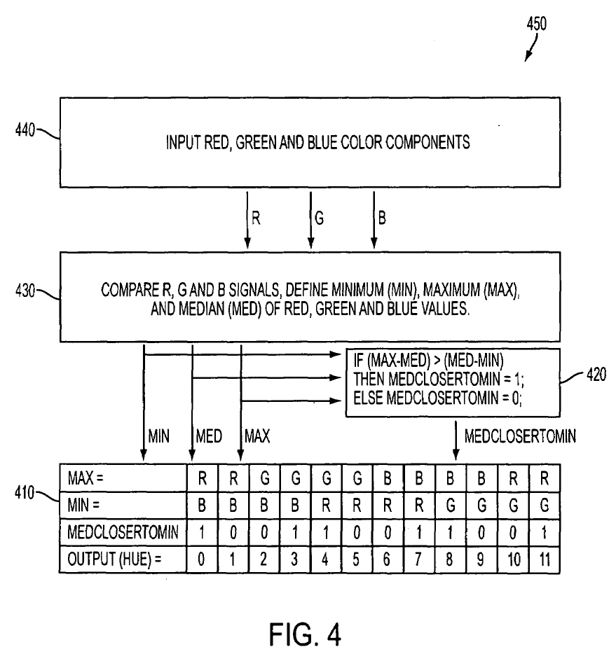

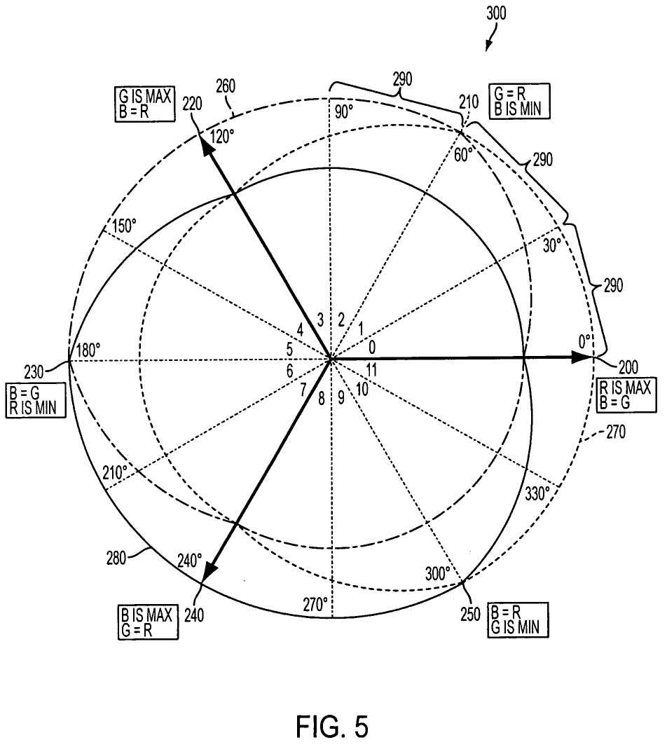

FIG. 4 illustrates a flowchart 450 and table 410 according to another embodiment of the invention where for Equation 2, P=2. Therefore, as shown in FIG. 5, the precision is 30°, and there are twelve segments 290 and twelve output hue values. To characterize each of the twelve segments 290, the conditionals are based on three quantitative traits (maximum (MAX), minimum (MIN), median (MED)) and one determined trait (MEDCloserToMIN). These traits are defined in steps 430 and 420 as follows:

if R≧B AND R>G then MAX=R;
if G≧R AND G>B then MAX=G;
if B≧G AND B>R then MAX=B;

if R≦B AND R<G then MIN=R;
if G≦R AND G<B then MIN =G;
if B≦G AND B<R then MIN =B;
if (G>R and R≧B) or (B≧R and R>G) then MED = R;
if (B>G and G≧R) or (R≧G and G>B) then MED = G;
if (R>B and B≧G) or (G≧B and B>R) then MED = B; and
if (MAX−MED) > (MED−MIN)
then MEDCloserToMin = 1
else MEDCloserToMin = 0.

As shown in FIG. 4, each output hue value may be determined by a set of conditionals, which are based on a combination of the MAX, MIN and MEDCloserToMin traits. In the FIG. 4 embodiment, inputting RGB values 440 of 1, 0.7, and 0.8, respectively, would yield the following results:

MAX = R
MIN = G
MEDCloserToMin = 1
OUTPUT: 11

### The output of 11 corresponds to a hue between 330°-0°. Using the conventional method of Equation 1:

H=60((0.7−0.8)/(1−0.7))=−20≈(360°+−20°)≈340°

### Thus, the method according to this embodiment of the invention estimates hue within a range of 30°. As shown from the calculated hue value H, this estimate is close to the calculated value.

FIG. 4 illustrates a set of conditionals where the number of segments meets the requirement of Equation 2. Selecting a number of segments satisfying Equation 2, ensures the existence of a set of conditionals that will not need complicated arithmetic operators. For example, according to Equation 2 the next qualified number of segments 290 after 12 (P=2) would be 24 (P=3). A preferred set of conditionals for P=3 could be based on the MAX, MIN, and MED traits used for P=2, and at least one determined trait, MED_INTERVAL. For example, the full range of values in a segment 290 (MAX-MIN) can be divided into intervals and the interval in which MED_INTERVAL falls would be calculated. Utilizing this technique, complex division can be replaced by shifting. In bit-wise operations, shifting N bits to the right equals division by 2^{N}, and shifting M bits to the left equals multiplication by 2^{M}. Therefore, by selecting S based on the constraints of Equation 2, complex division and multiplication can be avoided, and each successive set of conditionals may be based on traits calculated by further dividing the full range into intervals using shifting instead. Accordingly, MED_INTERVAL for P=3 could be defined in the following manner:

```
    MED_INTERVAL = 00;
    MED1_4 = (MAX − MIN) /4;
    MED2_4 = MED1_4 * 2;
    MED3_4 = MED1_4 + MED2_4;
    if (MAX−MED) < (MAX−MED3_4) then MED_INTERVAL = 11
(in other words, MED is closest to MAX);
    if (MAX−MED) < (MAX−MED2_4) then MED_INTERVAL =10
(in other words, MED is above MED2_4 but closer to MED2_4
then to MAX);
    if (MAX−MED) < (MAX−MED1_4) then MED_INTERVAL = 01
( in other words, MED is below MED2_4 but closer to MED2_4
then to MIN); and
    if (None of the above true) then MED_INTERVAL = 00 (default,
or in other words, MED closest to MIN).
```

It should be understood that the traits need not be defined in terms of a two-bit MED_INTERVAL. Instead, the trait may be defined by four one-bit variables or in some other way using the technique of defining the trait based on dividing the range between the MAX and MIN traits into intervals.

The output hue value table can be embedded on a chip or available in the system that will be needing it to determine the hue value approximation. This may be accomplished in any number of ways, including but not limited to programming, storing internally or externally, loading a look-up table of the output values, or building a circuit according to a truth table based on the output table. For example, in the imager 100 (FIG. 1) the traits are calculated, the conditionals are evaluated and the output hue value is determined by hardwired or software portion 190 of the image processor 180 according to stored table values. The output hue value is then further used by the image processor 180 in algorithms, operations and calculations that require a hue value.

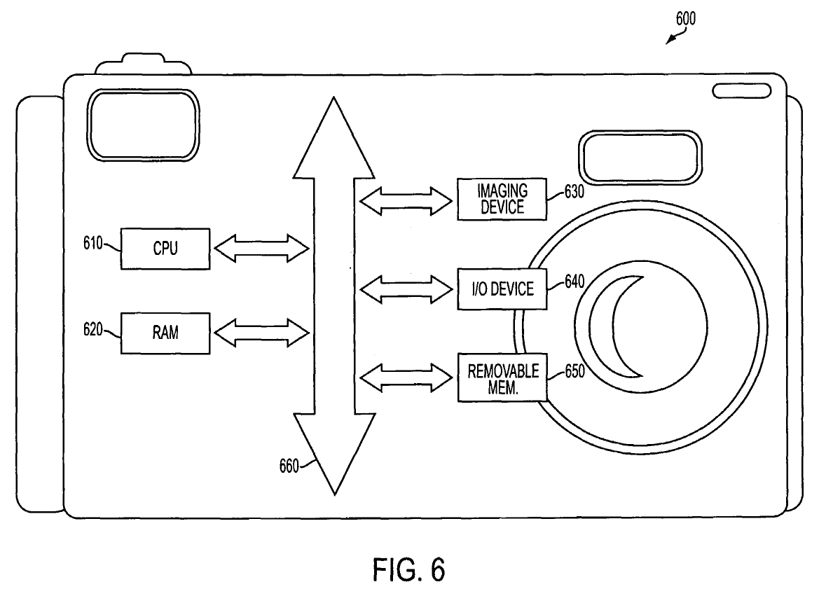

A typical processor system which may include an imager circuit 480 of the type illustrated in FIG. 1, but with image processor 180 programmed to implement a method of hue calculation according to the present invention. The image processor may have an associated internal or external memory for storing instructions or output values. The processor system may be a camera, which may be a digital still or video camera 600, or other type of camera, as shown in FIG. 6, or some other type of system. It should be noted that the illustration of a camera is not intended to be limiting and that such an imager circuit 680 could be included in any processor system including a computer system, scanner, machine vision, vehicle navigation, video phone, cell phone, personal digital assistant, surveillance system, auto focus system, star tracker system, motion detection system, and other systems employing an imager.

The illustrated camera system 600, generally comprises a central processing unit (CPU) 610, such as a microprocessor for controlling camera operations, that communicates with one or more input/output (I/O) devices 640 over a bus 660. The imaging device 630, also communicates with the CPU 610 over the bus 660. The system 600 also may include random access memory (RAM) 620, and can include removable memory 650, such as flash memory, which also communicate with the CPU 610 over the bus 660. The imaging device 630 may be combined with a processor, such as a CPU, digital signal processor, or microprocessor, with or without memory storage on a single integrated circuit or on a different ship than the processor.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications, permutations and variations as fall within the scope of the appended claims.

What is claimed as new and desired to be protected by Letters Patent of the United States is:

1. A method of determining hue values for an imager pixel, comprising:
defining a plurality of segments of a hue color circle at least in part with respective conditional statements which represent the hue characteristics of red, green and blue color components falling within respective segments, each of said segments having an associated hue output value;
inputting red, green and blue component values for a pixel;
determining a segment corresponding to said input color component values in accordance with said conditional statements, at least in part; and
outputting a hue value associated with said determined segment.

2. The method of claim 1, wherein the number of segments is twelve.

3. The method of claim 1, wherein the number of segments is twenty-four.

4. The method of claim 1, wherein the characteristics comprise maximum, minimum, or median values of the red, green, and blue component values.

5. The method of claim 1, wherein the segments are defined by a look-up table matching conditionals to segment output values.

6. A software product for causing a processor to determine hue values comprising:
a stored set of output hue values respectively corresponding to segments in a hue color wheel, said output hue values being respectively defined by one or more conditionals evaluating one or more traits based on quantitative characteristics of red, green, and blue color component values corresponding to the hue values represented within each segment;
stored instructions for obtaining pixel values representing red, green, and blue color component values;
stored instructions for analyzing the color component values in accordance with the one or more conditionals to determine a segment corresponding to the component values,
stored instructions for providing an output hue value associated with said determined segment.

7. The software product of claim 6 where said one or more conditionals do not include multiplier operations that cannot be executed through bit-wise shifting.

8. The software product of claim 6 where said one or more conditionals do not include division operations that cannot be executed through bit-wise shifting.

9. The software product of claim 6, wherein said one or more traits comprise maximum, minimum, or median values of the red, green, and blue component values.

10. The software product of claim 9, wherein said one or more traits further comprise dividing the range of maximum minus minimum into intervals to create at least one additional trait for use in creating the conditionals.

11. The software product of claim 6, wherein the total number of segments falls within the set of numbers satisfying the equation: S=3*2̂P, where S is the total number of segments.

12. A method of providing hue values in an image processing system, said method comprising the steps of:
designating a number segments of the hue color circle, each segment spanning respective first degree and second degree values and the sum total of all segments covering all possible values of the hue color circle, where the total number of segments falls within the set of numbers satisfying the equation: S=3*2̂P, where S is the total number of segments;
describing each segment by at least one conditional evaluating at least one trait based on quantitative characteristics of red, green, and blue color component values corresponding to the hue values represented within each segment, where the at least one conditional is true for all red, green, and blue values that correspond to the hue degree values between said first degree value and said second degree value of each segment;
assigning an output hue value to represent each segment such that each output hue value represents a range of hue values;
storing the output hue value assignments and the corresponding conditionals in said system.

13. The method of claim 12, further comprising:
obtaining input red, green and blue color component values;
analyzing the color component values in accordance with the one or more conditionals to determine a segment corresponding to the component values; and,
providing an output hue value associated with a determined segment.

14. The method of claim 13, where the zero degree angle of the hue circle is aligned with the first or second degree of one of said segments while P is greater than zero, and centrally aligned within a segment while P equals zero.

15. The method of claim 13, where the component color values are obtained from pixels cells in an imager circuit.

16. The method of claim 13, where the output hue values are embedded in a system-on-a-chip.

17. The method of claim 13, where the number of segments is twelve, and the traits are defined as follows:
if R≧B AND R>G then MAX=R;
if G≧R AND G>B then MAX=G;
if B≧G AND B>R then MAX=B;
if R≦B AND R<G then MIN=R;
if G≦R AND G<B then MIN =G;
if B≦G AND B<R then MIN =B; and
if (MAX−MED) > (MED−MIN)
then MEDCloserToMin = 1
else MEDCloserToMin = 0.

18. The method of claim 17, where the set of conditionals is defined as follows:
if MAX=R and MIN=B and MEDCloserToMIN=1 then output =0;
if MAX=R and MIN=B and MEDCloserToMIN=0 then output =1;
if MAX=G and MIN=B and MEDCloserToMIN=0 then output =2;
if MAX=G and MIN=B and MEDCloserToMIN=1 then output =3;
if MAX=G and MIN=R and MEDCloserToMIN=1 then output =4;
if MAX=G and MIN=R and MEDCloserToMIN=0 then output =5;
if MAX=B and MIN=R and MEDCloserToMIN=0 then output =6;
if MAX=B and MIN=R and MEDCloserToMIN=1 then output =7;
if MAX=B and MIN=G and MEDCloserToMIN=1 then output =8;
if MAX=B and MIN=G and MEDCloserToMIN=0 then output =9;
if MAX=R and MIN=G and MEDCloserToMIN=0 then output =10; and
if MAX=R and MIN=G and MEDCloserToMIN=1 then output =11.

19. An imaging system, comprising:
a device for storing a set of output hue values, said output hue values defined by at one or more conditionals evaluating at least one trait based on quantitative characteristics of a plurality of color component values; and,
a processor for determining hue by testing input red green and blue color component values against said conditionals to determine the output hue value corresponding to the input red, green and blue color component values.

20. The system of claim 19 wherein the plurality of color component values comprises red, green and blue color component values.

21. The system of claim 20 where said one or more conditionals do not include multiplier operations that cannot be executed through bit-wise shifting.

22. The system of claim 20 where said one or more conditionals do not include division operations that cannot be executed through bit-wise shifting.

23. The system of claim 20 wherein the traits comprise maximum, minimum, or median values of the red, green, and blue component values.

24. The system of claim 20 wherein the traits further comprise dividing the range of maximum minus minimum into intervals to create additional traits for use in creating the conditionals.

25. The system of claim 20 wherein said system is implemented in a system-on-a-chip.

26. A camera system, comprising:
a pixel array;
a device for storing a set of output hue values, said output hue values defined by at one or more conditionals evaluating at least one trait based on quantitative characteristics of red, green and blue color component values;
an image processor for determining hue by testing input red green and blue color component values from said pixel array against said conditionals to determine the output hue value corresponding to the input red, green and blue color component values.

27. The system of claim 26 where said one or more conditionals do not include multiplier operations that cannot be executed through bit-wise shifting.

28. The system of claim 26 where said one or more conditionals do not include division operations that cannot be executed through bit-wise shifting.

29. The system of claim 26 wherein the traits comprise maximum, minimum, or median values of the red, green, and blue component values.

30. The system of claim 26 wherein the traits further comprise dividing the range of maximum minus minimum into intervals to create additional traits for use in creating the conditionals.

31. A software storage medium, having a stored set of output hue values respectively corresponding to segments in a hue color wheel, said output hue values being respectively defined by one or more conditionals evaluating one or more traits based on quantitative characteristics of red, green, and blue color component values corresponding to the hue values represented within each segment

32. The software storage medium of claim 31 further comprising stored instructions for a processor to perform the acts of:
obtaining pixel values representing red, green, and blue color component values;
analyzing the color component values in accordance with the one or more conditionals to determine a segment corresponding to the component values; and
providing an output hue value associated with said determined segment.
